(19) United States
(12) Patent Application Publication
(10) Pub. No.: US 2024/0257338 A1
(43) Pub. Date: Aug. 1, 2024

(54) METHOD FOR PROCESSING IMAGES

(71) Applicant: P³LAB, CEROUX-MOUSTY (BE)

(72) Inventor: Pierre Martin Jack Gérard DAYE, Braine-l'alleud (BE)

(21) Appl. No.: 18/289,255

(22) PCT Filed: May 4, 2022
(86) PCT No.: PCT/EP2022/062055

§ 371 Date: Nov. 2, 2023

(30) Foreign Application Priority Data
May 5, 2021 (BE) 2021/5362

(51) Int. Cl. G06T 7/00; G06T 5/20; G06T 7/10; G06T 7/20

(52) U.S. Cl. CPC G06T 7/0012; G06T 5/20; G06T 7/10; G06T 7/20; G06T 2207/30041

(57) ABSTRACT

The disclosure relates to a method for processing images. The method comprises a recursive and preferably algorithmic determination of image processing functions for a sequence of images on the basis of a sequence of estimates of at least some of these functions.

### TECHNICAL FIELD

This invention relates to an image processing method.

### PRIOR ART

We know how to study images and their transformations in order to extract information. These studies are generally performed using computer and/or mathematical image processing methods for a variety of purposes.

For example, such methods can be used in facial recognition and tracking methods. However, they are complex to implement for tracking parts of the body that move very quickly or are difficult to grasp, such as an eye. In this case, the tracking results are not very accurate. In addition, the individual processing of the images considerably slows down the execution of such methods.

In order to solve this problem in the technical context of an eye-tracking, the prepublication arXiv 1706.08189 discloses a method for detecting a pupil in an image sequence from recursive estimates of characteristics of the pupil over the image sequence. However, the effectiveness of this method could be improved.

### DESCRIPTION OF THE INVENTION

The object of the invention is to provide a fast, reliable and efficient image processing method that takes full advantage of the current algorithmic advances.

To this end, the present invention proposes a computer-implemented image processing method comprising a determination of an image processing function of each image of an image sequence by means of the following steps:
(i) determining a sequence of estimates of the processing functions of at least some of the images;
(ii) determining the processing function of each image recursively over the sequence of images, based on the sequence of estimates.

Thanks to the method described in the invention, it is possible to process a sequence of images more quickly and efficiently using image processing functions. In fact, these functions are determined recursively on the sequence of images, and therefore deduced from each other. This allows to avoid an individual processing of the images, and therefore a longer execution time for the method, particularly in view of the above-mentioned prepublication presentation. This advantage is further enhanced by the fact that the processing functions of the images are determined from the estimate sequence (which may or may not itself be determined recursively), thus constituting an intermediate step that is simpler to execute than the direct processing of the images. Fewer calculations are therefore required, as determining a processing function is similar to adjusting a residual with respect to the estimate of this processing function. The recursive aspect of the method also increases the reliability of the determination of the image processing functions, as this is not based solely on the sequence of estimates but also on the functions already determined.

This method is better suited to tracking methods that are difficult to implement, such as an eye-tracking, as will be introduced below.

The term “processing function of images” (more simply “function”) refers preferably to a function defined on the pixels of the images and taking as values a model, and/or a structure, and/or a characteristic corresponding to the pixels of the images. For example, when a 2D model (e.g. a curve, a geometric shape, etc.) and/or 3D model (e.g. a volume, an orientation (data item), a position, etc.) associated with such a processing function can be highlighted at the pixel level of a first image in the sequence (algorithmically or manually), the method according to the invention allows to integrate this model advantageously and recursively into the other images in the sequence in order to track its evolution and/or detect it efficiently and quickly, without processing each image independently. Thus, for example, and preferably, the image processing function associates a model and/or a structure with a collection of pixels in the images (i.e., pixels having a “non-zero” (or non-constant) image by the function).

Such a structure may, for example, correspond to a segmentation of the images, so that according to a preferred embodiment of the method according to the invention, the image processing function defines a segmentation of the images. The segmentation as such is a well-known method known to a person skilled in the art. It can be of any known type. It can, for example, be based on regions and/or contours at the level of the images in the sequence, and/or also on a classification of the pixels by intensity (e.g., light, greyscale, etc.). This segmentation can be attached to a segmentation probability distribution integrated directly into the definition of the processing functions of the images. Given the large number of image processing functions that can be taken into account by the method according to the invention, this method allows a large number of image processing applications.

In the context of this document, as is known to a person skilled in the art, the determination of an “estimate” of a processing function is the determination of this function in an approximate manner, i.e., comprising a residual deviation from the actual function in question. In particular, the function and the associated estimate are typically of the same type and nature.

By using the terms “computer-implemented”, the method of the invention involves the use of a computer, a computer network and/or any other programmable (e.g., smartphone, tablet, FPGA, etc.) or programmed (e.g., integrated circuit/ASIC, etc.) apparatus. In particular, the term “computer” cannot be interpreted restrictively. The determination steps are therefore at least partly based on an underlying computer character. For example, one or more of these steps may consist of a determination by algorithmic calculation.

The use of the term “sequence of images” itself implies a notion of order between the images. However, the method does not depend on an order previously attached to the images. For example, the order considered in the method is not necessarily that in which the images are captured. For example, the method may well be preceded by a step of establishing an order between the images in order to form the sequence. The method can also be executed recursively in the reverse order in which the images are captured, so that the sequence considered would be in this reverse order. However, these considerations are ancillary to the invention, the essential point being that at some point a sequence of images is used as the input to the method, which is generally and preferably obtained by capturing the images in the order in which they are captured. For example, the sequence of images forms a sequence of images over time, representing, for example, a movement of a part of a human body, such as an eye. Alternatively, the sequence can also form a spatial sequence of images captured at adjacent positions (for example, by CT scan or CBCT scan), and/or a spatio-temporal sequence of images (for example, captured by 4D CT scan).

As is known to a person skilled in the art, and as explained in the method statement, the recursion of step (ii) is attached to this order between the images. In particular, the processing function of an image which is at least second in the sequence is determined from the sequence of estimates, preferably from its estimate, but also recursively on at least one of the functions already determined. This function is preferably the previous one in the sequence. However, the method according to the invention is not limited to this form of recursion. So, for example, the processing function of the nth image in the sequence can be determined on the basis of that of the n−1 th, and/or the n−2 nd, and/or the n−3 rd and/or etc., or on the basis of all the image processing functions already determined or known in one way or another. The term “recursively” can therefore also be interpreted as referring to a general inductive character of the image processing functions.

The mention of steps (i) and (ii) should not be interpreted as necessarily referring to an order of execution of the steps. In particular, steps (i) and (ii) are preferably executed alternately and/or simultaneously and/or in parallel on the images in the sequence. Thus, for example, according to a particular embodiment of the invention, steps (i) and (ii) are preferably implemented in the form of the following sub-steps, and in that order:
(0) determining or providing the processing function of a first of the images in the image sequence;
(1i) determining the estimate of the processing function of a second of the images in the sequence from the processing function of the first image;
(1ii) determining the processing function of the second image from the processing function of the first image and the estimate of the processing function of the second image;
(n) repeating steps (li) and (lii) recursively on the sequence of the images to determine successively:
   estimating the processing function of a current image in the image sequence from the processing function of a previous image in the image sequence;
   the processing function of the current image on the basis of the processing function of said image preceding in the sequence of images and the estimate of the processing function of the current image;
for each current image that is at least the third in the image sequence.

This embodiment of the method emphasises the recursive nature of determining the image processing functions on the image sequence. Step (0) forms the initial step, and steps (li), (lii) and (n) form the recursive step. In this case, the estimates of the image processing functions are obtained successively from the image processing functions preceding in the sequence. The processing function of the first image can be determined algorithmically or simply provided in some other way. These alternatives are discussed below in relation to the initial formulation of the method, and it will be readily understood by the person skilled in the art that each embodiment introduced below applies similarly to the formulation of steps (0) to (n).

The only member of the estimate sequence used to determine the processing function of an image is preferably that of the processing function of the current image, so that it is not necessary to know and/or determine the estimate sequence as a whole in order to determine a processing function of an image. The sequence of estimates of the processing functions preferably comprises an estimate of the processing function of each image from the second to the last image of the image sequence. The estimate of the processing function of the first image is not, for example, necessary according to an execution of sub-steps (0) to (n) above, since this function is directly determined or supplied as an initial step. Generally speaking, the estimate sequence may comprise one, two, three or more members relating to one, two, three or more images. For example, it may also be possible to form the sequence of estimates of the processing functions on all the images at a position that is a multiple of a number in the sequence.

According to another particular mode, the method according to the invention comprises, in this order, the steps:
(0) determining or providing the processing function of a first of the images in the image sequence;
(i′) determining a sequence of estimates of the processing functions of the second to last images of the image sequence on the basis of the processing function of the first image;
(ii′) determining the processing function of each image from the second to the last image of the image sequence, recursively over the image sequence, from the sequence of estimates.

In this particular case, step (i′) corresponding to step (i) is executed completely before step (ii′), which corresponds to step (ii). Step (i′) can, for example, be carried out by applying to the processing function of the first image a displacement of pixels between the first image and the image thus considered, as will be introduced below in terms of “neighbouring image”. Optionally, step (i′) can also be recursive over the sequence of the images.

As shown in the preceding paragraphs, the image processing method can therefore be executed in a number of different ways that are fully within the scope of the present invention.

In the context of this document, the terms “from”, “on the basis of” and similar terms must not be interpreted in a restrictive manner as “solely from”, “on the exclusive basis of”, etc., unless this is expressly indicated. These terms generally refer to a direct dependency, preferably without the need for an intermediate step or transformation. They can be equivalently substituted by “directly from”, “directly based on”, and so on.

The use of the verb “to understand”, its variants and its conjugations in this document in no way precludes the presence of elements other than those mentioned. The use, in this document, of an indefinite article such as “a” or “an”, or of a definite article such as “the”, to introduce an element does not exclude the presence of several such elements.

According to a preferred embodiment of the invention, the estimate of the processing function of a current image of the image sequence is determined in step (i) from:
the current image;
a neighbouring image preceding or following the current image in the image sequence whose processing function has been previously determined; and
the processing function of the neighbouring image.

The term “current image” preferably refers to any image for which the estimate of the processing function is currently being determined. Preferably, when the processing function of the first image in the sequence is determined or supplied in an initial step of the method, the current image is one of the images ranked second to last in the sequence. A “neighbouring image” preferably corresponds to an image directly preceding the current image in the sequence. For example, if the current image is the nth, then the neighbouring image is the (n−1)th, for n a natural number strictly greater than 1. However, this formulation does not exclude the case where the neighbouring image considered is not directly before or after the current image in the sequence. For example, only one image on T, for T a natural number greater than or equal to 2, could be considered a neighbouring image. For example, for T=2, the processing functions of the nth and (n+1)th images could be estimated on the basis of the same neighbouring image, in this case the (n−1)th image. A different example of a neighbouring image that does not directly follow or precede the current image in the sequence is the case where the neighbouring image is always the first image. This case has already been mentioned where the processing function of the first image has been determined or obtained in an initial step of the method. All these particular embodiments are fully within the scope of the invention according to this preferred embodiment.

Step (i) preferably comprises a comparison between the current image and the neighbouring image. Advantageously, this comparison allows the processing function of the current image to be estimated particularly easily by applying and/or passing on the result of the comparison to the known processing function of the neighbouring image.

More preferably, the comparison comprises (and preferably consists of) a determination of a vector field. Such a vector field is then preferably based on the pixels of the current image. The vector field preferably corresponds to a displacement of pixels between the current image and the neighbouring image. In this case, it preferentially encodes the displacement that the pixels would have to undergo to return to a position associated with the neighbouring image. This vector field is then preferably calculated by optical flow. Alternatively, the vector field can define a derivative of the pixel-by-pixel variation in intensity between the current image and the neighbouring image.

The data of the vector field is preferably equivalent to the data from the estimate of the processing function of the neighbouring image, so that step (i) of the method can correspond to the data from a collection of vector fields, each preferably corresponding to a displacement of pixels between two of the sequence images (or alternatively to the aforementioned derivative). In this case, preferably, this collection of vector fields would then be obtained by comparing the pairs of images classified (n−1, n)th for each natural number n from 2.

In the general case where the comparison comprises the determination of the vector field, the estimate of the processing function of the current image is then preferably determined in step (i) by a composition of the vector field with the processing function of the neighbouring image. Mathematically, if the processing function of the neighbouring image is denoted f and if the vector field is denoted X and assimilated to a displacement of image pixels, the estimate of the processing function of the current image at pixel p is given by (f∘X)(p).

The estimate of the processing function of the current image is in some ways a first-order approximation of this function, in much the same way as a tangent at a point on the graph of a real-valued function provides a first-order approximation of the function in the vicinity of the point. Such approximations are easy to calculate, which further improves the efficiency and the speed of executing the method according to the invention.

In the case of image processing functions associating a model and/or a structure with a collection of pixels of the images, for example a segmentation of images of a part of a body (for example, an eye) for the purposes of tracking a sub-part of this body (for example, a limbus of the eye), these latter embodiments allow to deduce easily a precise estimate of position of the sub-part of the body to be tracked on each image, and thus to greatly limit an area of interest of the image on which to identify the sub-part of the body in step (ii) of the method. This area is all the more limited, and the estimate all the more reliable, if the sub-part of the body to be tracked is overall stationary relative to the part of the body between two consecutive images, which is generally the case, for example, for a continuous stream of video images of this part of the body (for example, around twenty images per second), in particular when this part consists of an eye.

The estimate of the processing function of the current image is preferably determined algorithmically in step (i), for example using a “daemon” type algorithm. Step (i) is preferably determined using a Kalman filter. The advantage of this is that a more accurate result can be achieved in a shorter time.

According to a preferred embodiment of the invention, an execution of steps (i) and (ii) begins with a determination of the processing function of a first image of the image sequence from input data comprising this first image. This determination then constitutes an initial step (0) in step (ii) of the method as described above. In particular, the processing function of the first image can be determined in a different way, or simply provided as input to the method on the basis of the first image.

According to a preferred embodiment of the invention, the processing function of an image to be processed which is at least second in the sequence of images, and whose the estimate of the processing function has previously been determined, is determined in step (ii) from (optionally “only from”) input data comprising:
the image to be processed;
the estimate of the processing function of the image to be processed; and
the processing function of an image preceding (preferably directly) the image to be processed in the image sequence.

This embodiment then constitutes the recursive step of step (ii) as introduced previously. In particular, in this case, the processing function of the image to be processed is determined recursively from the processing function of the previous image.

Advantageously, the determination of the processing function in step (ii) is made more efficient because it can be carried out on the basis of a determination of the residual remaining with its estimate. The calculations required for this are therefore limited, allowing the method to be integrated into embedded systems with limited computing power.

The term “image to be processed” preferably corresponds to the current image when this embodiment is combined with the previous embodiments of determining the estimate of the processing function of the image to be processed. The neighbouring image in these embodiments then preferably corresponds to the image preceding the image to be processed. As mentioned above, however, step (i) is not limited to this particular neighbouring image.

The input data preferably comprises all or some of the images preceding the image to be processed in the image sequence. They preferably comprise all or some of the image processing functions preceding the image to be processed in the image sequence. In this way, the entire sequence of the images and/or the functions already determined are used to determine more precisely the processing function of the image to be processed in step (ii). The method is therefore more accurate and more robust, given the error propagation limitation induced by the recursive aspect.

The processing function of the image to be processed is preferably determined algorithmically in step (ii) from the input data.

This algorithmic implementation is preferably carried out by means of a neural network that has been developed and trained prior to steps (i) and (ii) to determine the processing function of the image to be processed in step (ii) from the input data.

Preferably the same also applies to the processing function of the first image, so that the input data comprising the first image is supplied to the neural network to determine this function. These input data are preferably the same for each image, i.e., the image to be processed, the estimate of the processing function of the image to be processed, and the processing function of the image preceding the image to be processed, so that the inputs which are not available when the determination of the processing function of the first image are assimilated to empty (or unavailable) inputs, without jeopardising the correct execution of the algorithm. The processing function of the first image is therefore determined on the basis of less input data, without this affecting the accuracy of the subsequent processing functions, given the recursive nature of step (ii) and the exemplary use of Kalman filters in the execution of step (i) to determine the estimates of these functions. The execution of the method is thus particularly efficient and reliable.

The neural network can be trained using principles known to a person skilled in the art, such as back-propagation of an error gradient. So, for example, in this training:
the network is initiated with random weights,
initial input data, corresponding to an initial image, is supplied to the neural network to determine an output data which should correspond to a processing function of the initial image, this function being otherwise known,
an error between the known function and the output data is calculated and propagated backwards through the neural network,
the values of the weights of the neural network are updated,
the last three steps are repeated with other initial input data and other corresponding known functions, to refine the values of the weights of the network in a progressive and iterative way.

The invention also proposes an eye-tracking method that benefits from the advantages of the method described in the invention. The eye-tracking method comprises the following steps:
(a). providing a sequence of images of an eye;
(b). segmenting the images at least in the vicinity of a representation of the iris of the eye;
(c). determining the position of a limbus of the eye on the basis of the segmentations of the images in step (b);
(d). determining a position of the eye on the basis of the position of the limbus of the eye determined in step (c).

Preferably, step (b) is implemented by means of the method according to the invention for which the image processing function defines an image segmentation. The term “position” may be replaced above by the term “position information or data”.

The method allows to provide a rapid and accurate eye-tracking compared with known methods in the prior art. The segmentation of each image is performed by means of the image processing method of the invention in such a way that each segmentation is deduced from a segmentation estimate and from at least one of the preceding segmentations in a recursive manner, thus allowing to achieve a high precision and a high speed in the execution of this step (b). The segmentation of an image of the eye in the vicinity of the pixels associated with the iris of the eye allows to highlight an elliptical shape in the case of a contour segmentation, corresponding essentially to the limbus of the eye, the position of which can thus advantageously be deduced in step (c) according to the parameters defining the ellipse. The advantage of this method also lies in the fact that segmentations can be processed more quickly and with less effort than with images.

In addition, the method according to the invention proposes to first take account of the limbus to determine the position of the eye in step (d), and thus differs from most known methods which rely on data relating to the pupil to determine the position of the eye. Indeed, determining the position of the eye using such a method, typically by segmenting the images in the vicinity of the pixels corresponding to the pupil as in the prepublication of the prior art, is less accurate than the method according to the present invention. This is because the determination of position characteristics of the pupil using such a method is fraught with errors due, for example, to the fact that the speed and the acceleration of the eye movements (which can reach 600°/s and 35,000°/s² respectively during saccades) induce a relative movement between the pupil and the limbus of the eye, or to the fact that any black stain (e.g., mascara) is taken into account in the calculations by most current eye trackers.

Thus, the method according to the invention is advantageously distinguished by the structure of steps (a) to (d) allowing a position of the limbus of the eye to be established, but also by the advantageous implementation of step (b) by the method of the invention. In particular, all the embodiments and advantages of the method according to the invention naturally extend mutatis mutandis to step (b) of the eye-tracking method according to the invention, and hence to this method.

The speed and the efficiency of the eye-tracking method also make it particularly interesting for tracking an eye over a continuous stream of video images, which constitutes a preferred embodiment of the method according to the invention.

The image sequence is then provided in the form of this image stream, for example, by means of a camera pointed at the eye. The subject to whom the eye belongs is typically stimulated to follow a moving target on a screen, thereby allowing to capture a sequence of movement images of the eye. The eye-tracking method allows to study the movements of the eye, for example, in order to detect neurodegenerative diseases. This method can also be used for the eye-tracking of the eyes of a driver of a vehicle in order to detect and warn if the driver is nodding off. The applications of the eye-tracking method are of course not limited to these examples.

According to a preferred embodiment of the method, step (c) comprises determining a position characteristic of a pupil of the eye on the basis of the segmentations of the images of step (b). In particular, this may be the case because the neighbourhood of the pixels corresponding to the iris comprises the pixels corresponding to the edge of the pupil, and therefore each segmentation allows to deduce such a characteristic. This preferably corresponds to the contour, area and/or barycentre of the pupil as represented in the image in question.

The position of the eye is then preferably determined in step (d) on the basis of the characteristic position of the pupil of the eye and of the position of the limbus of the eye determined in step (c), which allows to obtain an even more accurate eye-tracking.

Preferably, when the method of step (ii) of step (b) is implemented by means of a neural network, the method comprises, prior to step (b), a method for training the neural network by back-propagating a gradient of errors at the level of the neural network (for example, of weight values) on the basis of a sequence of test images of an eye looking at a target located at a predetermined position on a screen. In particular, since the position of the target is known, the orientation and the position of the eye is also known, which allows to deduce the result that should be obtained, and therefore to calculate the errors and propagate them backwards within the neural network, in accordance with the training method as described above. This forms a practical realisation of the training and the way in which an effective neural network can be obtained, particularly in the context of the eye-tracking method.

The person skilled in the art will understand that the eye-tracking method according to the present invention is only one application among others of the image processing method according to the invention. For example, it can also be used for other purposes such as the facial recognition within computer programs, for example in video-conferencing software filters to distinguish a face from its surroundings. The image processing method according to the invention can also be used to detect tumours in images, for example radiographic images, via CT scan and/or CBCT.

The invention also proposes a data processing (computer) system comprising means configured to implement the image processing method according to any of the embodiments of the invention. The invention also proposes a computer program comprising instructions which, when the computer program is executed by a computer, cause it to implement the method according to any one of the embodiments of the invention. Finally, the invention also proposes a computer-readable medium on which the above-mentioned computer program is recorded.

The data processing system comprises, for example, at least one computer hardware of:
a computer equipped with a processor for executing algorithms, preferably with a PC-type architecture or an embedded-type architecture (ARM);
an ASIC integrated circuit specific to an application and/or an algorithm;
an FPGA logic integrated circuit that can be reconfigured or reprogrammed after manufacture.

The data processing system is preferably an embedded system. This embodiment is advantageously made possible by the combined use of estimates and a recursion on the determination of the processing functions, allowing to reduce the number of calculations and the computing power required to execute the method according to the invention.

The computer-readable medium preferably consists of at least one computer medium (or a set of such media) capable of storing digital information. It comprises, for example, at least one of the following: a digital memory, a server, a USB key or a computer. It can be in a cloud.

The embodiments and the advantages of the method according to the invention are transposed mutatis mutandis to the data processing computer system, the computer program and the computer readable medium according to the invention.

### BRIEF DESCRIPTION OF THE FIGURES

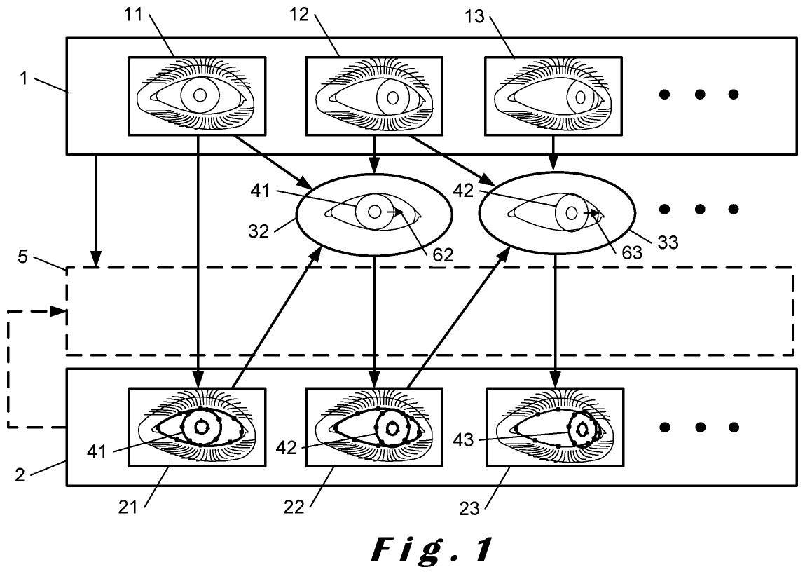

Other characteristics and advantages of the present invention will become apparent from the following description, reference to which is made in FIG. 1, which shows a flowchart of an image processing method according to a preferred embodiment of the invention.

The drawings in the FIGURE are not to scale. Similar elements can be denoted by similar references. For the purposes of this document, the identical and/or similar elements may bear the same references. The presence of reference numbers or letters in the drawings cannot be regarded as restrictive, even when these numbers or letters are indicated in the claims.

### DETAILED DESCRIPTION OF AN EMBODIMENT OF THE INVENTION

This section describes a preferred embodiment of the present invention with reference to FIG. 1. It is schematic and does not limit the invention. By abuse of notation, the image processing functions will be denoted as their images on the pixels of the image sequence.

FIG. 1 shows the execution of the method according to this embodiment in the preferred case where the image processing function defines an image segmentation. As explained above, this embodiment is particularly advantageous for the purposes of the eye-tracking method described above. In order to highlight this application in the description, the sequence of images 1 in FIG. 1 is made up of successive images 11, 12, 13 which represent, in a non-limiting way, a moving eye (from the centre towards the right in the illustrated drawing) and which are captured in the form of a video stream from a camera.

The images comprise a first image 11 of the sequence 1 on the basis of which the method algorithmically determines, in the initial step (0) of step (ii), a processing function, the image of which is illustrated in reference 41, thereby providing a first segmented image 21. In the case of FIG. 1, and in a non-limiting way, three areas contours are represented at pixel level corresponding to the pupil, to the limbus and to the contour of the eye.

This function 41 is obtained algorithmically by a previously developed and trained neural network 5 having as input data the images of the image sequence 1 and the sequence 2 comprising segmented images 21, 22, 23, or equivalently, the processing functions 41, 42, 43 of the images 11, 12, 13, progressively recursively determined by step (ii) of the method according to the invention. In this case, the sequence 2 is still empty when function 41 is determined.

In another step of the method, the images 11 and 12 are compared to deduce a vector field 62 corresponding to a displacement of pixels between the images, this vector field being combined with the function 41 to deduce an estimate 32 of the processing function of the image 12. As illustrated in FIG. 1, the vector field corresponds to the displacement from the image 11 to the image 12 applied to the image of the function 41 above the pixels of the image 11 to obtain an estimate of the image of the function 42. However, the purpose of this illustration is to show how estimate 32 is obtained. The vector field 62 corresponds in practice to a non-rigid deformation between the images, and applies mathematically to the pixels of the images 12 as explained in the description of the invention. However, all these data are equivalent, as will be readily understood by the person skilled in the art, the data of the estimate 32 also being equivalent to that of the vector field 62 given that the method is recursive.

This estimate 32 is then used as input data for the neural network 5, in combination with the image sequences 1 and 2 (the latter comprising the single segmented image 21 at this stage or, equivalently, the function 41), to deduce a correction for the estimate 32, and so as to define the processing function 42 of the image 12.

These steps are then iterated. A comparison between the images 12 and 13 yields the vector field 63 which, combined with the function 42, allow to deduce an estimate 33 of the processing function 43 of the image 13. This estimate 63 is then used as input data by the neural network 5, in combination with the image sequences 1 and 2 (the latter comprising at this stage the images 21 and 22, or equivalently the functions 41, 42) to deduce the function 43, and thus obtain the segmented image 23. And so, on recursively through the sequence 1 (corresponding to the “ . . . ” shown).

In brief, the present invention relates to an image processing method comprising a recursive, and preferably algorithmic, determination of image processing functions 41, 42, 43 of a sequence of images 11, 12, 13 on the basis of a sequence of estimates 32, 33 of at least some of these functions.

The present invention has been described above in relation to a preferred and/or specific embodiment of purely illustrative and non-limiting value. Generally speaking, it will be obvious to a person skilled in the art that the present invention is not strictly limited to the examples illustrated and/or described in this text.

1. A computer-implemented image processing method comprising a determination of an image processing function of each image of an image sequence comprising the following steps:
(i) determining a sequence of estimates of the processing functions of at least some of the images; and
(ii) determining the processing function of each image recursively over the sequence of images, on the basis of the sequence of estimates.

2. The method according to claim 1,
wherein the estimate of the processing function of a current image of the image sequence is determined in step from:
the current image;
neighbouring image preceding or following the current image in the image sequence, and whose processing function has been determined beforehand; and
the processing function of the neighbouring image.

3. The method according to claim 2,
wherein step (i) comprises a comparison between the current image and the neighbouring image.

4. The method according to claim 3,
wherein the comparison comprises a determination of a vector field corresponding to a displacement of pixels between the current image and the neighbouring image.

5. The method according to claim 4,
wherein the vector field is computed by optical flow.

6. The method according to claim 4,
wherein the estimate of the processing function of the current image is determined in step (i) by a composition of the vector field with the processing function of the neighbouring image.

7. The method according to claim 2,
wherein the estimate of the processing function of the current image is algorithmically determined in step (i) by a Kalman filter.

8. The method according to claim 1,
wherein an execution of steps (i) and (ii) begins with a determination of the processing function of a first image of the image sequence from input data comprising this first image.

9. The method according to claim 1,
wherein the processing function of an image to be processed is at least second in the image sequence, and
wherein the processing function estimate has been determined beforehand, and is determined in step (ii) from input data comprising:
the image to be processed;
the estimate of the processing function of the image to be processed; and
the processing function of an image preceding the image to be processed in the image sequence.

10. The method according to claim 9,
wherein the input data further comprises:
several of the images preceding the image to be processed in the image sequence; and/or
several of the processing functions of images preceding the image to be processed in the image sequence.

11. The method according to claim 9,
wherein the processing function of the image to be processed is determined algorithmically in step from input data.

12. The method according to claim 11,
wherein step (ii) is carried out by means of a neural network which has been developed and trained prior to steps (i) and (ii) in order to determine the processing function of the image to be processed at step (ii) on the basis of the input data.

13. The method according to claim 1, wherein the image processing function associates a model and/or a structure with a collection of pixels from the images.

14. The method according to claim 1, wherein the image processing function defines an image segmentation.

15. An eye-tracking method comprising the following steps:
(a) providing a sequence of images of an eye;
(b) segmenting the images at least in the vicinity of a representation of the iris of the eye;
c) determining the position of a limbus of the eye on the basis of the segmentations of the images of step (b); and
(d) determining a position of the eye on the basis of the position of the limbus of the eye determined at step (c),
wherein step (b) is implemented by a computer-implemented image processing method comprising a determination of an image processing function of each image of an image sequence comprising the following steps:
(i) determining a sequence of estimates of the processing functions of at least some of the images; and
(ii) determining the processing function of each image recursively over the sequence of images, on the basis of the sequence of estimates,
wherein the image processing function defines an image segmentation.

16. The eye-tracking method of claim 15, wherein
step (c) comprises determining a position characteristic of a pupil of the eye on the basis of the segmentations of the images of step (b), and
the position of the eye is determined at step (d) on the basis of the position characteristic of the pupil of the eye and of the position of the limbus of the eye determined at step (c).

17. The eye-tracking method according to claim 15,
wherein step (ii) is carried out by a neural network which has been developed and trained prior to steps (i) and (ii) in order to determine the processing function of the image to be processed at step (ii) on the basis of the input data; and
prior to step (b), comprising:
a method for training the neural network by back-propagating an error gradient at the level of the neural network on the basis of a sequence of test images of an eye looking at a target located at a predetermined position on a screen.

18. A data processing computer system configured to implement the method according to claim 1.

19. A computer program comprising instructions that, when the computer programme is executed by a computer, lead the latter to implement the method according to claim 1.

20. A computer-readable medium on which the computer program according to claim 19 is recorded.
